(19) United States
(12) Patent Application Publication
(10) Pub. No.: US 2017/0293349 A1
(43) Pub. Date: Oct. 12, 2017

(54) LIGHTING SYSTEM CONTROL METHOD, COMPUTER PROGRAM PRODUCT, WEARABLE COMPUTING DEVICE AND LIGHTING SYSTEM KIT

(71) Applicant: PHILIPS LIGHTING HOLDING B.V., EINDHOVEN (NL)

(72) Inventors: JONATHAN DAVID MASON, WAALRE (NL); SANAE CHRAIBI, EINDHOVEN (NL); DZMITRY VIKTOROVICH ALIAKSEYEU, EINDHOVEN (NL); BERENT WILLEM MEERBEEK, EINDHOVEN (NL)

(21) Appl. No.: 15/507,916

(22) PCT Filed: Aug. 31, 2015
(86) PCT No.: PCT/EP2015/069874

§ 371 Date: Mar. 1, 2017

(30) Foreign Application Priority Data
Sep. 1, 2014 (EP) 14183010.9

(51) Int. Cl. G06F 3/01; H05B 37/02

(52) U.S. Cl. CPC G06F 3/011; G06F 3/017; H05B 37/0272; H05B 37/029

(57) ABSTRACT

A method is disclosed for controlling a lighting system including at least one luminaire with a wearable computing device comprising a see-through display and an image capturing element, the method comprising, with the wearable computing device, capturing, with the image capturing element, an image of a space including a luminaire of said lighting system, said image corresponding to an actual view of said space through the see-through display; identifying the luminaire in said image; displaying a desired lighting atmosphere on said see-through display; associating the luminaire in said actual view with the desired lighting atmosphere; and communicating with the lighting system to instruct the luminaire to recreate said lighting atmosphere. A computer program product for implementing this method on a wearable computing device, a wearable computing device including this computer program product and a lighting system kit including the computer program product or wearable computing device are also disclosed.

### FIELD OF THE INVENTION

The present invention relates to a method for controlling a lighting system including at least one luminaire with a wearable computing device comprising a display and an image capturing element.

The present invention further relates to a computer program product for implementing such a method when executed on a processor of such a wearable computing device.

The present invention yet further relates to a wearable computing device adapted to implement such a control method.

The present invention still further relates to lighting system kit adapted to be controlled by such a control method.

### BACKGROUND OF THE INVENTION

The introduction of new lighting technologies such as solid state lighting has revolutionized the provisioning of lighting solutions, for instance by a shift from functional lighting to decorative lighting systems designed to create aesthetic lighting effects, e.g. complex lighting atmospheres created by a single or multiple luminaires to create a particular ambiance in a space such as a room, theatre, office and so on, as the luminaires of the lighting system are typically configurable, e.g. programmable, to create light of varying colour, colour temperature intensity and/or periodicity, e.g. constant lighting, pulsed lighting, flashing lighting and so on. Such lighting systems therefore allow a user to create user-defined ambiances or by configuring individual luminaires or combinations of luminaires in the lighting system to create a desired lighting atmosphere.

A user may create such a desired lighting atmosphere by programming the lighting system accordingly. However, a large number of luminaires may form part of such a lighting system, for instance because the lighting system not only comprises dedicated luminaires but additionally comprises electronic devices including such luminaires, e.g. display devices, music equipment, kitchen appliances and so on having supplementary luminaire functionality, such that a large number of luminaires can contribute to the creation of the desired lighting atmosphere.

Users can be put off by the complexity of the configuration task of such lighting systems, as the definition of the desired lighting atmosphere includes the task of identifying a large number of different luminaires and providing each of the luminaires with the appropriate configuration instructions in order to create the desired lighting atmosphere by selecting the appropriate combination of configuration options across the pool of configurable luminaires, which is a far from trivial exercise for large lighting systems.

Attempts have been made to facilitate such a configuration task, for instance by providing software applications (apps) for mobile devices, e.g. smart phones or tablets, in which the user can associate an image including a particular colour with a luminaire of the lighting system. To this end, the luminaire is selected from a list of luminaires presented by the lighting system. An example of such an app can be found within the Hue® lighting system marketed by the Royal Dutch Philips Company, which app allows the creation and control of an interconnected lighting system by controlling luminaires with a mobile device hosting the app, which mobile device communicates with a wireless bridge of the lighting system to which the luminaires are connected.

Although such an app allows the user to create a lighting atmosphere in a more intuitive manner, it still requires the user to have knowledge about the identity of the luminaire in the lighting system, such that the task of configuring the lighting system in accordance with the desired lighting atmosphere can still be cumbersome for large lighting systems, e.g. lighting systems comprising tens of luminaires.

US 2013/0069985 A1 discloses a wearable computing device including a head-mounted display (HMD) that provides a field of view in which at least a portion of the environment of the wearable computing device is viewable. The HMD is operable to display images superimposed over the field of view. When the wearable computing device determines that a target device is within its environment, the wearable computing device obtains target device information related to the target device. The target device information may include information that defines a virtual control interface for controlling the target device and an identification of a defined area of the target device on which the virtual control image is to be provided. The wearable computing device controls the HMD to display the virtual control image as an image superimposed over the defined area of the target device in the field of view. This facilitates an intuitive control mechanism for such a target device.

However, this control method relies on the target device providing the required control information, which is unsuitable for controlling luminaires in a lighting system, as the luminaires are typically unaware of the mode of operation required by a user.

WO 2013/088394 A2 and WO 2012/049656 A2 each disclose a method and apparatus for interactive control of a lighting environment using a user interaction system.

### SUMMARY OF THE INVENTION

The present invention seeks to provide a method for controlling a lighting system including a plurality of luminaires in a more intuitive manner.

The present invention further seeks to provide a computer program product for implementing such a method.

The present invention yet further seeks to provide a wearable computing device adapted to execute such a computer program product.

The present invention still further seeks to provide a lighting system including such a wearable computing device.

According to an aspect, there is provided a method for controlling a lighting system including at least one luminaire with a wearable computing device comprising a display and an image capturing element, the method comprising, with the wearable computing device, capturing, with the image capturing element, an image of a space including a luminaire of said lighting system, said image corresponding to an actual view of said space through the see-through display; identifying the luminaire in said image; displaying an image of a desired lighting atmosphere on said see-through display; associating the luminaire in said actual view with the desired lighting atmosphere; and communicating with the lighting system to instruct the luminaire to recreate said lighting atmosphere.

The present invention is based on the insight that the introduction of wearable computing devices including see-though displays has provided the wearer of such a device with an additional control dimension to configure luminaires of a lighting system to recreate a desirable lighting atmosphere. Such luminaires may form an ad-hoc lighting system or may form part of a centrally controlled lighting system. Specifically, the ability to simultaneously visualise a part of such a lighting system through the see-through display and displaying a desired lighting atmosphere on the see-through display facilitates a particularly intuitive association of the desired lighting atmosphere with one or more luminaires in that part upon identification of the one or more luminaires by the wearable computing device.

The association may be based on the identification of a single luminaire in the captured image of the actual view. Alternatively, the actual view may include several luminaires of said lighting system, and wherein said identifying step comprises identifying each of said several luminaires and said associating step comprises associating at least one of said several luminaires in said actual view with the desired lighting atmosphere. In an embodiment, each of the identified luminaires is associated with the desired lighting atmosphere.

The associating step may comprise selecting a luminaire in said actual view. Such a selection step may be advantageously implemented by overlaying the selected luminaire in the actual view with the displayed desired lighting atmosphere. This is a particularly intuitive manner of selecting the luminaire to be instructed to recreate the desired lighting atmosphere.

The method may further comprise calculating a lighting characteristic for the luminaire from the displayed desired lighting atmosphere with the wearable computing device, wherein said instructing step includes communicating the calculated lighting characteristic from the wearable computing device to the lighting system. This lighting characteristic can be used as an instruction or basis thereof for the luminaire, such that the luminaire may recreate the desired lighting atmosphere in accordance with said instruction. Such an instruction may be communicated directly to the luminaire, e.g. in the case of a luminaire including wireless communication facilities, or may be communicated indirectly to the luminaire, e.g. through a wireless communication facility of a lighting system to which the luminaire belongs.

In an embodiment, the lighting characteristic includes at least one of light colour, intensity, saturation, colour temperature and lighting dynamics extracted from one or more pixels of said display displaying the desired lighting atmosphere. Additionally or alternatively, metadata associated with the one or more pixels and indicative of the lighting characteristic may be used to extract the lighting atmosphere. The metadata may form part of the image or sequence of images displayed on the display.

In a particularly advantageous embodiment, the step of displaying a desired lighting atmosphere comprises displaying an image of the desired lighting atmosphere. Such an image may be obtained by capturing the image with the image capturing element or retrieving the image from an external source. This provides the wearer of the wearable computing device with great flexibility in specifying the desired lighting atmosphere, as the wearer simply may simply capture or retrieve this further image.

The desired lighting atmosphere may be a static lighting effect. Alternatively, the image of the desired lighting atmosphere may form part of a sequence of images defining a dynamic desired lighting atmosphere, and wherein said communication step comprises instructing the lighting system to recreate the dynamic desired lighting atmosphere. This facilitates the generation of more elaborate or complex lighting atmospheres, e.g. time-varying lighting atmospheres, with the lighting system.

The method may further comprise communicating an adjustment to a lighting atmosphere recreated by the luminaire from the wearable computing device to the lighting system in response to an adjustment instruction received by the wearable computing device. This provides a user of the wearable computing device with the functionality to adjust a lighting atmosphere recreated by the one or more luminaires of the lighting system in case the initial recreation attempt is not entirely satisfactory.

In an embodiment, the method further comprises displaying a virtual luminaire on said see-through display; and migrating the virtual luminaire to a location in the actual view to create an augmented view depicting an augmented lighting atmosphere in accordance with a migration command received by the wearable computing device. In this manner, the wearer of the wearable computing device may create a virtual lighting atmosphere including virtual luminaires, for instance for the purpose of trialling the addition of a luminaire to an existing lighting system without having to purchase the luminaire. This therefore reduces the risk that the wearer is disappointed by an extension to the lighting system because of the extension not providing the desired lighting effect.

The method may further comprise controlling, at the lighting system, the luminaire in accordance with the received communication to recreate the desired lighting atmosphere. Such controlling may be invoked by a dedicated controller of the luminaire, e.g. by direct communication with the luminaire or by a system controller controlling a multitude of luminaires in a lighting system, e.g. by indirect communication with the luminaire through the system controller.

In accordance with another aspect, there is provided a computer program product comprising a computer-readable medium embodying computer program code for, when executed on a processor of a wearable computing device further comprising a see-through display and an image capturing element, implementing the steps of the method of any of the above embodiments. Such a computer program product may be made available to the wearable computing device in any suitable form, e.g. as a software application (app) available in an app store, and may be used to configure the wearable computing device such that the wearable computing device can implement the aforementioned method.

In accordance with yet another aspect, there is provided a wearable computing device comprising such a computer program product; a processor adapted to execute the computer program code; a see-through display; an image capturing element; and a communication arrangement for communicating with a lighting system. Such a wearable computing device is therefore capable of controlling a lighting system including at least one luminaire in accordance with one or more embodiments of the aforementioned method.

In accordance with a further aspect, there is provided a lighting system kit comprising at least one luminaire and the aforementioned computer program product or wearable computing device. Such a lighting system kit benefits from being controllable in a more intuitive manner, thereby facilitating a greater user appreciation of the lighting system, i.e. the one or more luminaires, for instance because the user may be less likely to be discouraged to configure the lighting system because of its complexity, e.g. in the case of lighting systems comprising many luminaires.

### BRIEF DESCRIPTION OF THE DRAWINGS

Embodiments of the invention are described in more detail and by way of non-limiting examples with reference to the accompanying drawings, wherein:

FIG. 1 schematically depicts a lighting system kit in accordance with an example embodiment;

FIG. 2 depicts a flowchart of a method for controlling a lighting system in accordance with an embodiment;

FIGS. 3 and 4 schematically depict an example control scenario for controlling luminaires of a lighting system in accordance with said method;

FIGS. 5 and 6 schematically depict another example control scenario for controlling luminaires of a lighting system in accordance with said method;

FIGS. 7 and 8 schematically depict yet another example control scenario for controlling luminaires of a lighting system in accordance with said method;

FIG. 9-11 schematically depict an example scenario for creating a virtual lighting scene in accordance with a method according to another embodiment; and

FIG. 12 depicts a flowchart of a method for creating a virtual lighting scene in accordance with another embodiment.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

In the context of the present application, a wearable computing device is a device that provides a user with computing functionality and that can be configured to perform specific computing tasks as specified in a software application (app) that may be retrieved from the Internet or another computer-readable medium. A wearable computing device may be any device designed to be worn by a user on a part of the user's body and capable of performing computing tasks in accordance with one or more aspects of the present invention. Non-limiting examples of such wearable devices include smart headgear, e.g. eyeglasses, goggles, a helmet, a hat, a visor, a headband, or any other device that can be supported on or from the wearer's head.

In the context of the present application, a luminaire is a device capable of producing a configurable light output, wherein the light output may be configured in terms of at least one of colour, colour point, colour temperature, light intensity, to produce a dynamic light effect, and so on. In some embodiments, the luminaire may include solid state lighting elements, e.g. light-emitting diodes, arranged to create the aforementioned configurable light output. The luminaire may be a dedicated lighting device or may form part of an electronic device having a primary function other than providing a lighting effect. For example, the luminaire may form part of a display device, a household appliance, music equipment, and the like.

A lighting system is a system that can communicate in a wireless fashion with the wearable computing device. In a basic embodiment, the lighting system may comprise a single luminaire adapted to wirelessly communicate with the wearable computing device in a direct fashion. In a more elaborate embodiment, a lighting system may comprise a plurality of luminaires, each adapted to wirelessly communicate with the wearable computing device in a direct fashion. In yet another embodiment, at least some of the luminaires of the lighting system are adapted to wirelessly communicate with the wearable computing device in an indirect fashion through a wireless bridge or the like of the lighting system, wherein the luminaires are communicatively coupled to the wireless bridge or the like.

In the context of the present application, a lighting atmosphere is a lighting effect to be created by one or more luminaires such that the combination of these lighting effects creates a particular ambience or atmosphere within a space housing the luminaires of a lighting system. Such a lighting effect at least includes a definition of a colour to be produced by the one or more luminaires, and may further include an intensity of the light effect to be produced by the one or more luminaires, a periodicity or frequency of the light effect to be produced by the one or more luminaires, and so on. A lighting atmosphere may be defined by a set of static light effects or by a set of light effects that change over time in order to create a dynamic lighting atmosphere.

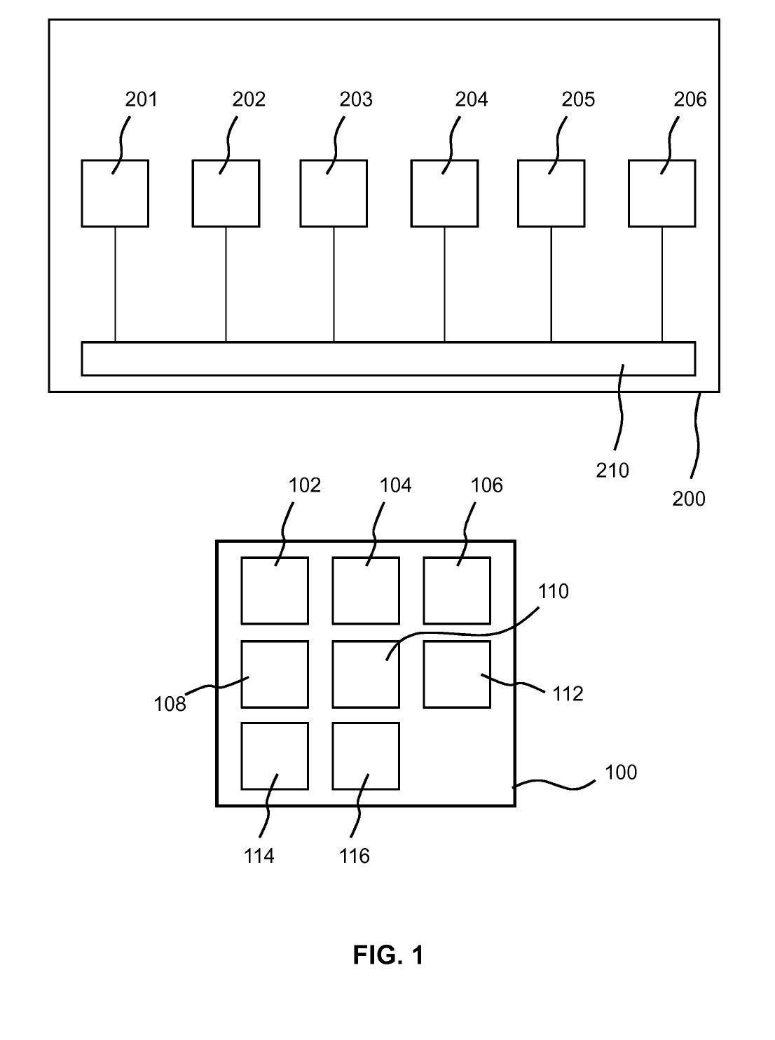

FIG. 1 schematically depicts a lighting system kit including a lighting system 200 and a wearable computing device 100 that is capable to wirelessly communicate with the lighting system 200, e.g. through a wireless bridge 210 of the lighting system 200 to which a plurality of luminaires 201-206 may be communicatively coupled in a wired and/or wireless fashion. Alternatively, at least some of the luminaires 201-206 of the lighting system 200 may be adapted to directly communicate with the wearable computing device 100 in a wireless fashion. The luminaires 201-206 for instance may define an ad-hoc lighting system 200. Any suitable wireless communication protocol may be used for any of the wireless communication between the wearable computing device 100 and the lighting system 200 and/or between various components of the lighting system 200, e.g., an infrared link, Zigbee, Bluetooth, a wireless local area network protocol such as in accordance with the IEEE 802.11 standards, a 2G, 3G or 4G telecommunication protocol, and so on.

Although not specifically shown in FIG. 1, the luminaires 201-206 in the lighting system 200 may be controlled in any suitable manner; for instance, each luminaire 201-206 may have a dedicated controller for receiving control instructions, e.g. through the wireless bridge 210 or through direct wireless communication with the wearable computing device 100. Alternatively or additionally, the lighting system 200 may comprise one or more central controllers for controlling the luminaires 201-206. It should be understood that any suitable control mechanism for controlling the lighting system 200 and the luminaires 201-206 may be contemplated. It should furthermore be understood that the lighting system 200 of FIG. 1 is shown with six luminaires by way of non-limiting example only; the lighting system 200 may comprise any suitable number of luminaires, i.e. one or more luminaires.

In accordance with embodiments of the present invention, the lighting system 200 may be controlled by a wearable computing device 100 having a see-through display 106, e.g. a head-mounted display. The see-through display 106 makes it possible for a wearer of the wearable computing device 100 to look through the see-through display 106 and observe a portion of the real-world environment of the wearable computing device 100, i.e., in a particular field of view provided by the see-through display 106 in which one or more of the luminaires 201-206 of the lighting system 200 are present.

In addition, the see-through display 106 is operable to display images that are superimposed on the field of view, for example, an image of a desired lighting atmosphere, e.g. an image having a particular colour characteristic to be reproduced by the one or more luminaires 201-206 in the field of view. Such an image may be superimposed by the see-through display 106 on any suitable part of the field of view. For instance, the see-through display 106 may display such an image such that it appears to hover within the field of view, e.g. in the periphery of the field of view so as not to significantly obscure the field of view.

The see-through display 106 may be configured as, for example, eyeglasses, goggles, a helmet, a hat, a visor, a headband, or in some other form that can be supported on or from the wearer's head. The see-through display 106 may be configured to display images to both of the wearer's eyes, for example, using two see-through display units. Alternatively, the see-through display 106 may include only a single see-through display and may display images to only one of the wearer's eyes, either the left eye or the right eye.

A particular advantage associated with such a see-through display 106, e.g. a head-mounted display, is that the wearer of the wearable computing device may view an actual lighting scene, i.e. a space or part thereof including at least one of the luminaires of the lighting system 200 through the see-through display 106, i.e. the see-through display 106 is a transparent display, thereby allowing the wearer to view the lighting scene in real-time.

In an embodiment, the wearable computing device 100 includes a wireless communication interface 102 for wirelessly communicating with the lighting system 200, e.g. with the wireless bridge 210 or directly with at least some of the luminaires 201-206. The wearable computing device 100 may optionally comprise a further wireless communication interface 104 for wirelessly communicating with a further network, e.g. a wireless LAN, through which the wearable computing device 100 may access a remote data source such as the Internet. Alternatively, the wearable computing device 100 may include one wireless communication interface that is able to communicate with the lighting system 200 and/or at least some of the luminaires 201-206 and the further network.

The functioning of wearable computing device 100 may be controlled by a processor 110 that executes instructions stored in a non-transitory computer readable medium, such as data storage 112. Thus, processor 110 in combination with processor-readable instructions stored in data storage 112 may function as a controller of wearable computing device 100. As such, the processor 110 may be adapted to control the display 106 in order to control what images are displayed by the display 106. The processor 110 may further be adapted to control wireless communication interface 102 and, if present, wireless communication interface 104.

In addition to instructions that may be executed by processor 110, data storage 112 may store data that may facilitate the identification of luminaires 201-206 of the lighting system 200. For instance, the data storage 112 may function as a database of identification information related to luminaires 201-206. Such information may be used by the wearable computing device 100 to identify luminaires 201-206 that are detected to be within the aforementioned field of view.

The wearable computing device 100 may further include an image capturing device 116, e.g. a camera, configured to capture images of the environment of wearable computing device 100 from a particular point-of-view. The images could be either video images or still images. Specifically, the point-of-view of image capturing device 116 may correspond to the direction in which the see-through display 106 is facing. In this embodiment, the point-of-view of the image capturing device 116 may substantially correspond to the field of view that see-through display 106 provides to the wearer, such that the point-of-view images obtained by image capturing device 116 may be used to determine what is visible to the wearer through the see-through display 106.

As described in more detail below, the point-of-view images obtained by camera 26 may be used to detect and identify luminaires 201-206 that are within the point-of-view images, e.g. an image of a space containing one or more of the luminaires 201-206, as well as to establish a connection with such luminaires in case of a P2P connection between the wearable computing device 100 and the identified luminaires, as will be explained in more detail below. The image analysis to identify the one or more luminaires 201-206 within a point-of-view image may be performed by processor 110. Alternatively, processor 110 may transmit one or more point-of-view images obtained by the image capturing device 116 to a remote server, e.g. via wireless communication interface 102, for the image analysis to be performed on the remote server. When the remote server identifies a luminaire in a point-of-view image, the remote server may respond with identification information related to the identified luminaire.

The luminaires 201-206 may be identified in any suitable manner. For instance, each luminaire may transmit coded light, e.g. light including a modulation that is characteristic for that particular luminaire, i.e. identifying the particular luminaire. The coded light may be received by the image capturing device 116, and the corresponding signal including the coding generated by the image capturing device 116 may be decoded by the processor 110 to identify the corresponding luminaire. The coded light may further be used as part of a handshake protocol to establish a P2P wireless connection between the identified luminaire and the wearable computing device 100 in embodiments where wearable computing device 100 wirelessly communicates with the identified luminaire in a direct fashion.

Alternatively, each luminaire may comprise a unique visible marker, such that when an image of a field-of-view is captured by the image capturing device 116, the processor 110 may process the captured image in order to recognize the unique visible markers and identify the luminaires accordingly. In yet another embodiment, the wearable computing device 100 may store, e.g. in data storage 112, known locations of the luminaires 201-206, e.g. in the form of images of the luminaires 201-206 in the space in which the luminaires 201-206 are placed, such that the luminaires may be identified by comparing the image of the field of view captured with the image capturing device 116 with the images stored in data storage 112. Other suitable identification techniques will be apparent to the skilled person.

The wearable computing device 100 may further comprise one or more sensors 114, e.g. one or more motion sensors, such as accelerometers and/or gyroscopes for detecting a movement of the wearable computing device 100. Such a user-induced movement for instance may be recognized as a command instruction, as will be explained in more detail below. In an embodiment, one of the sensors 114 may be a sound sensor, e.g. a microphone, e.g. for detecting spoken instructions by the wearer of the wearable computing device 100. In this embodiment, the processor 110 may be adapted to receive the sensing output from the sound sensor 114, to detect the spoken instruction in the received sensing output and to operate the wearable computing device 100 in accordance with the detected spoken instruction.

The wearable computing device 100 may further include a user interface 108 for receiving input from the user. User interface 108 may include, for example, a touchpad, a keypad, buttons, a microphone, and/or other input devices. The processor 110 may control at least some of the functioning of wearable computing device 100 based on input received through user interface 108. For example, processor 110 may use the input to control how see-through display 106 displays images or what images see-through display 106 displays, e.g. images of a desired lighting atmosphere selected by the user using the user interface 108.

In a particularly advantageous embodiment, the processor 110 may also recognize gestures, e.g. by the image capturing device 116, or movements of the wearable computing device 100, e.g. by motion sensors 114, as control instructions for one or more luminaires. Thus, while the display 106 displays an image of a desired lighting atmosphere for one or more target luminaires of the lighting system 200 in the actual view presented to the wearer through the see-through display 106, the processor 110 may analyze still images or video images obtained by the image capturing device 116 to identify any gesture that corresponds to a control instruction for associating the desired lighting atmosphere with the one or more target luminaires.

In some examples, a gesture corresponding to a control instruction may involve the wearer physically touching the luminaire, for example, using the wearer's finger, hand, or an object held in the wearer's hand. However, a gesture that does not involve physical contact with the luminaire, such as a movement of the wearer's finger, hand, or an object held in the wearer's hand, toward the luminaire or in the vicinity of the luminaire, could also be recognized as a control instruction.

Similarly, while the display 106 displays an image of a desired lighting atmosphere for one or more target luminaires of the lighting system 200, the processor 110 may analyze movements of the wearable computing device 100 detected by one or more of the sensors 114 to identify any movement, e.g. a head movement in case of a head-mountable computing device, corresponding to a control instruction for associating the desired lighting atmosphere with the one or more target luminaires.

Although FIG. 1 shows various components of wearable computing device 100, i.e., wireless communication interfaces 102 and 104, processor 110, data storage 112, one or more sensors 114, image capturing device 116 and user interface 108, as being separate from see-through display 106, one or more of these components may be mounted on or integrated into the see-through display 106. For example, image capturing device 116 may be mounted on the see-through display 106, user interface 108 could be provided as a touchpad on the see-through display 106, processor 110 and data storage 112 may make up a computing system in the see-through display 106, and the other components of wearable computing device 100 could be similarly integrated into the see-through display 106.

Alternatively, the wearable computing device may be provided in the form of separate devices that can be worn on or carried by the wearer. The separate devices that make up wearable computing device could be communicatively coupled together in either a wired or wireless fashion.

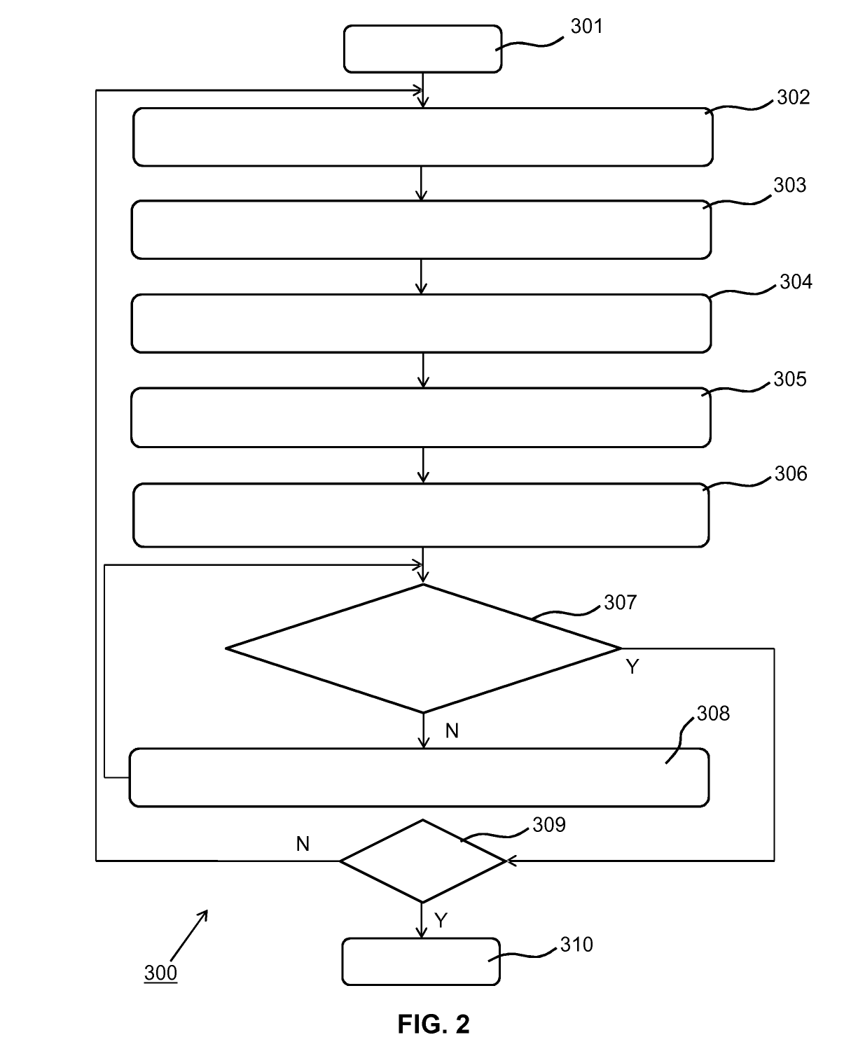

FIG. 2 depicts a flow chart of a lighting system 200 control method 300 to be implemented by the wearable computing device 100. The method 300 commences in step 301 after which the method proceeds to step 302 in which a view of a space including one or more luminaires 201-206 is provided to a user, e.g. through the see-through display 106. In step 303, an image of this actual view is captured for the purpose of identifying the one or more luminaires 201-206 in the image of the actual view. Step 303 typically further includes identifying the one or more luminaires 201-206 in the captured image, which identification may be achieved in any suitable manner as previously explained.

In step 304, the see-through display 106 is configured to display an image of a desired lighting atmosphere, which image may be selected by the user of the wearable computing device 100. The selected image for instance may be an image retrieved by the wearable computing device 100 from an external data source such as the Internet or may instead by an image captured by the image capturing element 116, e.g. in response to the wearer taking an image of the desired lighting atmosphere. The latter embodiment has the advantage that it for instance allows the user of the wearable computing device 100 to capture a particularly pleasing colour scene with the image capturing element 116, either prior to or during the configuration of the lighting system 200 by the method 300, such that the user may reproduce the particularly pleasing colour scene using one or more luminaires 201-206 in the lighting system 200.

Alternatively, the image containing the desired lighting atmosphere may contain a colour palette or the like, which optionally may be automatically extracted from an appropriate image captured by the wearable computing device or from the Internet. As this is well-known per se, e.g. from the Adobe Kuler app that extracts a colour palette in real-time from a smart phone camera input on which the app is installed, this will not be explained in further detail for the sake of brevity only. In this case, the user of the wearable computing device 100 may select the desired colour from the displayed colour palette, e.g. by using the user interface 108.

In step 305, one or more of the luminaires 201-206 identified in the image of the actual view may be associated with the displayed desired lighting atmosphere, for instance by the wearer of the wearable computing device 100 providing an association instruction to the wearable computing device 100. In an embodiment, the association instruction may be a global association instruction in the sense that all the luminaires identified in the actual view are associated with the desired lighting atmosphere by the association instruction. In an alternative embodiment, the provision of the association instruction may be for the purpose of selecting a subset of the luminaires, e.g. a single luminaire, in the actual view to be associated with the desired lighting atmosphere.

Such a selection may for instance be achieved by controlling the wearable computing device 100 such that the displayed desired lighting atmosphere is moved across the field of view of the see-through display 106 to a location in which the displayed desired lighting atmosphere image overlays the luminaire to be selected, e.g. by dragging the displayed desired lighting atmosphere image across the actual view onto the luminaire to be selected.

Such a dragging action may for instance be achieved by detection of eye or head movement or a gesture of the wearer of the wearable computing device 100. Other suitable selection mechanisms will be apparent to the skilled person; for instance, the processor 110 may generate a list of identified luminaires on the see-through display 106, in which case the wearer may associate the desired lighting atmosphere with one or more luminaires in said list, e.g. by using the user interface 108, by spoken instruction to be detected by a sound sensor 114, and so on.

The association instruction may be provided in any suitable manner. In a particularly advantageous embodiment, the wearer of the wearable computing device 100 provides the association instruction by a head movement, eye movement, e.g. gazing or blinking, or hand or finger gesture, which may be recognized by the wearable computing device 100, i.e. by the processor 110, as previously explained.

However, the association instruction alternatively may be provided by the wearer of the wearable computing device 100 in spoken form, by interacting with the user interface 108 of the wearer of the wearable computing device 100, e.g. by touching one or more control buttons on the wearable computing device 100. The association instruction may further be provided by maintaining the actual view beyond a defined threshold period, e.g. for longer than a defined time period, by overlaying a luminaire to be selected with the image of the desired lighting atmosphere beyond a defined threshold period, e.g. for longer than a defined time period. Other examples of suitable ways of providing the association instruction will be apparent to the skilled person.

In an alternative embodiment, the association instruction may be provided by scaling the displayed desired lighting atmosphere image to the field-of-view of the wearer of the wearable computing device 100 through the see-through display 106, in which case each identified luminaire 201-206 may be associated with the part of the scaled displayed desired lighting atmosphere that overlays the identified luminaire in the field-of-view.

In step 306, the processor 110 formulates a lighting control instruction for the one or more luminaires that have been associated with the desired lighting atmosphere and communicates this lighting control instruction to the lighting system 200, e.g. to the wireless bridge 210 of the lighting system 200 for communication to the respective controllers (not shown) of the one or more luminaires that have been associated with the desired lighting atmosphere, or directly to these controllers in case these controllers are adapted to establish a direct wireless communication with the wearable computing device 100 as previously explained.

The processor 110 may extract the lighting control instruction from the desired lighting atmosphere in any suitable manner. For instance, the processor 110 may determine a colour and/or colour intensity characteristic from the desired lighting atmosphere by evaluating pixel characteristics of the desired lighting atmosphere displayed on the see-through display 106.

In an embodiment, the pixel characteristic may be obtained from a particular region of the desired lighting atmosphere or may be obtained by calculating an average pixel characteristic from a plurality of pixels of the image of the desired lighting atmosphere.

In an embodiment, multiple lighting control instructions may be derived from a single image of a desired lighting atmosphere, for instance a discrete lighting control instruction for each identified luminaire in the actual view through the see-through display 106. This for instance may be used to create multi-tonal desired lighting atmospheres.

The lighting parameters may be directly extracted from the pixels or pixel parameters, or may be extracted from pixel parameters pre-processed, e.g. on the processor 110, for instance in the case of dynamic lighting atmospheres, where the pre-processing may include selecting colours that are most common to the individual desired lighting atmosphere images defining the dynamic lighting effect, wherein the common colours and transitions in these common colours between individual images may be used to define the desired dynamic lighting atmosphere.

In another embodiment, the desired lighting atmosphere image may be a visual representation of the desired lighting atmosphere further including metadata defining the lighting parameters associated with the visual representation, e.g. to describe the lighting atmosphere irrespective of spatial decomposition. Alternatively, the metadata may include spatial parameters such that when a user aligns a specific part of the image with a particular luminaire, the metadata associated with the selected spatial region of the image (or image pixels) may be used to generate a control instruction for the selected luminaire.

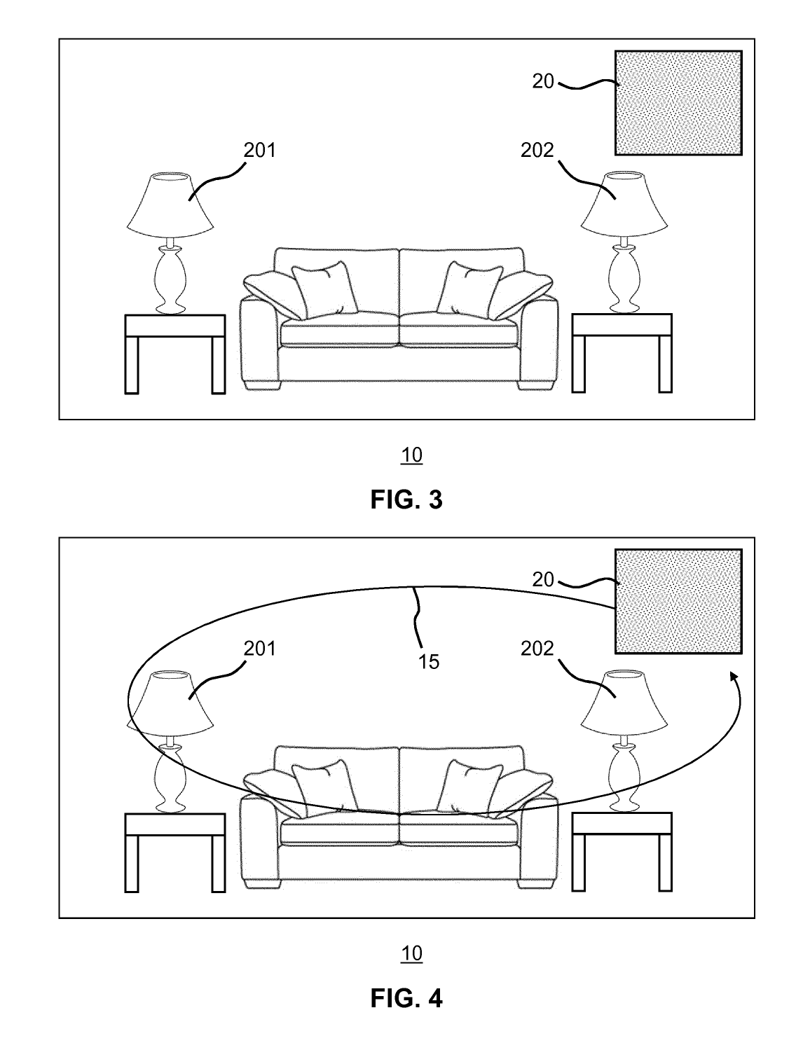

Upon communication of the one or more lighting control instructions to the lighting system 200 by the wearable computing device 100 as explained above, the lighting system 200 may recreate the desired lighting atmosphere by operating the luminaires associated with the desired lighting atmosphere in accordance with the received one or more lighting control instructions, e.g. by causing the luminaires to generate light having the desired lighting characteristics, e.g. the desired colour. This is not explicitly shown in FIG. 3, but may for instance form part of step 306 or may be a separate step subsequent to step 306.

Upon recreation of the desired lighting atmosphere by the lighting system 200, the method may optionally proceed to step 307 in which the wearer of the wearable computing device 100 can indicate if the recreated lighting atmosphere is acceptable to the wearer. For instance, the wearer may provide the wearable computing device 100 with an adjustment instruction, e.g. to adjust a setting, i.e. a lighting characteristic, such as light intensity of one or more of the luminaires associated with the recreation of the desired lighting atmosphere. The luminaires to be adjusted may be identified as previously explained, e.g. by identifying the one or more luminaires in a view of the wearer of the wearable computing device 100 through the see-through display 106.

Such an adjustment instruction may for instance be provided by the wearer making an eye movement, head movement, voice command, gesture or the like to communicate the adjustment instruction to the wearable computing device 100. For example, the wearer of the wearable computing device 100 may make an upward head movement to indicate that a light intensity of the one or more luminaires associated with the recreation of the desired lighting atmosphere should be increased or may make a downward head movement to indicate that a light intensity of the one or more luminaires associated with the recreation of the desired lighting atmosphere should be decreased. It should be understood that these are non-limiting example embodiments of such adjustment instructions and that any suitable adjustment instruction that may be recognized by the wearable computing device 100 may be used for this purpose.

In response to the wearable computing device 100 receiving the adjustment instruction from its wearer, the wearable computing device 100 communicates the adjustment instruction to the lighting system 200. Such a communication may be achieved as previously explained in more detail for step 306. The lighting system 200 subsequently adjusts the settings of the targeted luminaires 201-206 in accordance with the received adjustment instruction in step 308.

The method subsequently may proceed to optional step 309, in which it may be checked if the wearer of the wearable computing device 100 wants to assign the desired lighting atmosphere or another desired lighting atmosphere to another space, i.e. to other luminaires 201-206 of the lighting system 200 that are oriented in a different space. If the wearer indicates that such further assignments are to be made, e.g. by providing the wearable computing device 100 with a suitable instruction, the method may revert back to step 302 in order to assign the luminaires in the further space with the desired lighting atmosphere for that space. Once the process of generating the desired lighting atmosphere with the lighting system 200 has been completed, the method 300 terminates in step 310.

Some of the aspects of the present invention will now be explained in more detail by way of the following non-limiting examples.

FIG. 3 schematically depicts an example actual view 10 of a space including a first luminaire 201 and a second luminaire 202 of the lighting system 200 as seen through the see-through display 106 by a wearer of the wearable computing device 100. The see-through display 106 further displays an image 20 of a desired lighting atmosphere, here by way of non-limiting example in the periphery of the actual view 10. The image 20 may be an image captured by the image capturing element 116 of the wearable computing device 100 or retrieved by the wearable computing device 100 from an external data source such as the Internet as previously explained. Hence, in accordance with an aspect, a wearer of the wearable computing device 100 is presented with a real-time view 10 of a space including one or more luminaires 201, 202 through the see-through display 106 whilst at the same time being presented with a representation, e.g. image 20, of a desired lighting atmosphere, such that the wearer can associate the luminaires 201, 202 in the actual view 10 with the desired lighting atmosphere, e.g. with a desired colour to be reproduced by the luminaires 201, 202.

Such an association for instance may be achieved by the wearer providing an instruction to the wearable computing device 100, e.g. by a movement 15 of the head as schematically shown in FIG. 4, which may be detected by one or more motion sensors 114 of the wearable computing device 100. The wearable computing device 100 operates in accordance with an embodiment of the method 300 by identifying the luminaires 201, 202, by creating a control instruction for the identified luminaires 201, 202 from the image 20 and by communicating the control instruction to the lighting system 200 as previously explained, thereby configuring the lighting system 200 to operate the luminaires 201, 202 in accordance with the desired lighting atmosphere. It is reiterated that the aforementioned head movement as instruction is a non-limiting example of the provisioning of such an association instruction, and that the association instruction may be provided in any suitable manner as previously explained.

In the example of FIGS. 3 and 4, a global association instruction is used to associate all identified luminaires 201, 202 in the actual view to the desired lighting atmosphere in the image 20. However, it may be desirable to associate one or more particular luminaires in such an actual view 10 with the desired lighting atmosphere. This for instance may be achieved by providing a selection instruction to the wearable computing device 100 in which a specific luminaire of the lighting system 200 is selected.

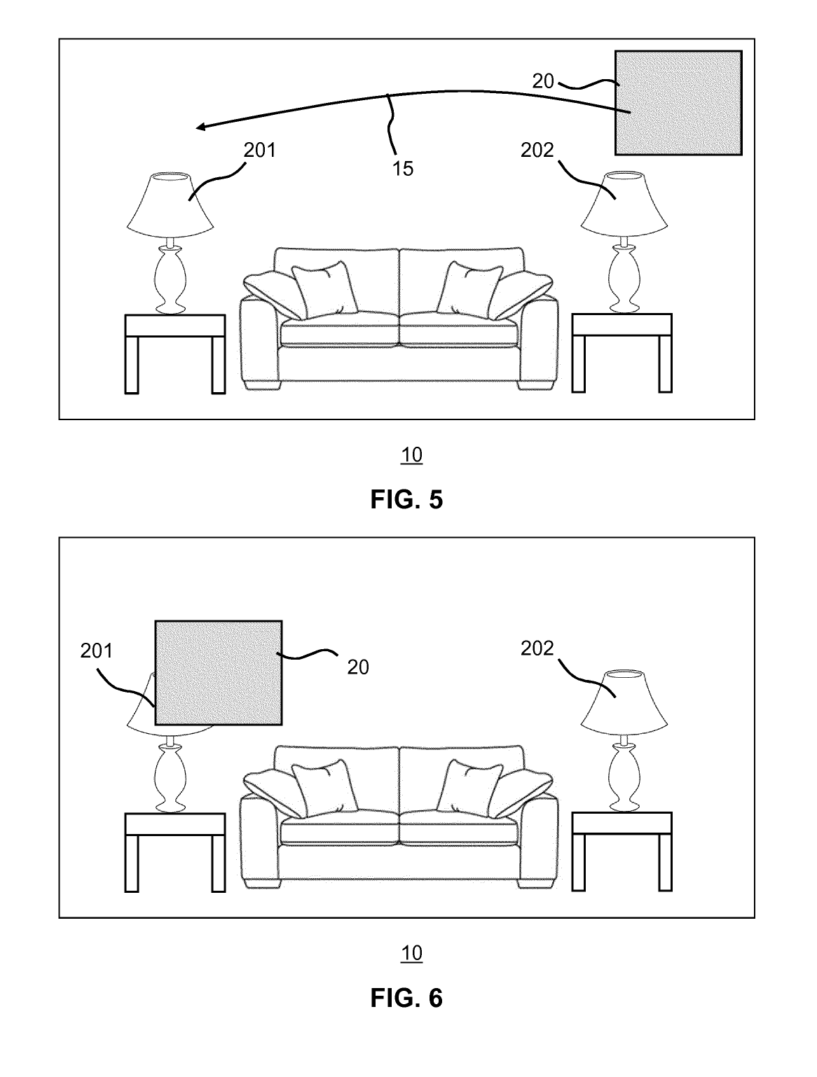

A non-limiting example of such a selection instruction is schematically shown in FIGS. 5 and 6, in which a wearer of the wearable computing device 100 may make a head movement, which causes the image 20 of the desired lighting atmosphere to be dragged towards a luminaire to be selected by tracking the head movement with one or more motion sensors 114 of the wearable computing device 100. The wearer seeks to achieve that the image 20 overlays the luminaire to be selected (here luminaire 201) in the actual view 10. This overlay is detected by the wearable computing device 100 and interpreted as the association of the luminaire 201 with the desired lighting atmosphere depicted in image 20. Such a selection process may be repeated if multiple individual luminaires are to be selected within a single actual view 10. Again it is reiterated that the selection instruction may take any suitable shape as previously explained, e.g. a gesture, spoken instruction, a selection instruction provided by the user interface 108, and so on.

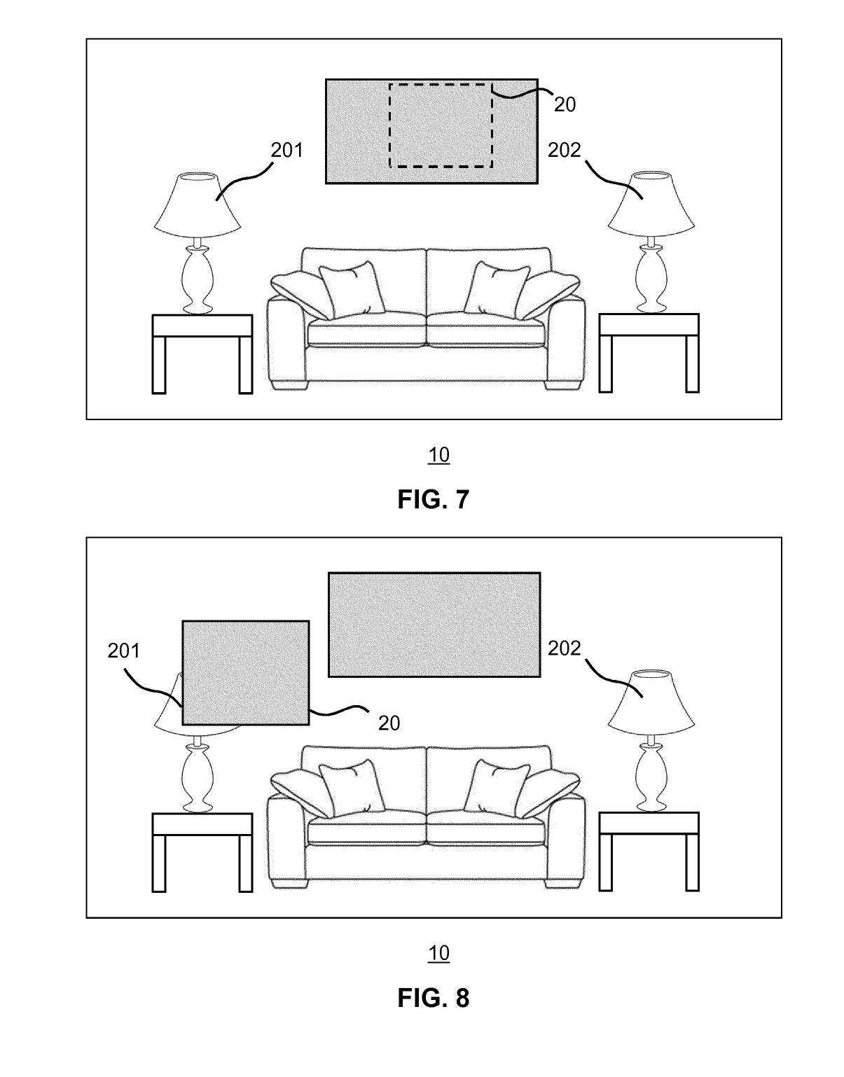

The image 20 of the desired lighting atmosphere may be generated in any suitable manner, for instance by downloading the image 20 from an image repository or by capturing the image 20 using the image capturing device 116 of the wearable computing device. Such an image may for instance be captured during the day, e.g. by capturing a particularly aesthetically pleasing scene in a location remote to the space in which the lighting system 200 is arranged. Alternatively, such an image 20 may be captured within the space in which the lighting system 200 is arranged, for instance to replicate a particular colour aspect in said space with selected luminaires of the lighting system 200. This for instance may be achieved as schematically shown in FIGS. 7 and 8. As shown in FIG. 7, the wearer of the wearable computing device 100 may capture an object having particular colour characteristics within the space housing the lighting system 200 in the image 20 in order to associate one or more selected luminaires with the captured image 20 in order for the selected luminaires to recreate the desired lighting atmosphere, here a lighting atmosphere that matches a colour theme of the object captured in the image 20.

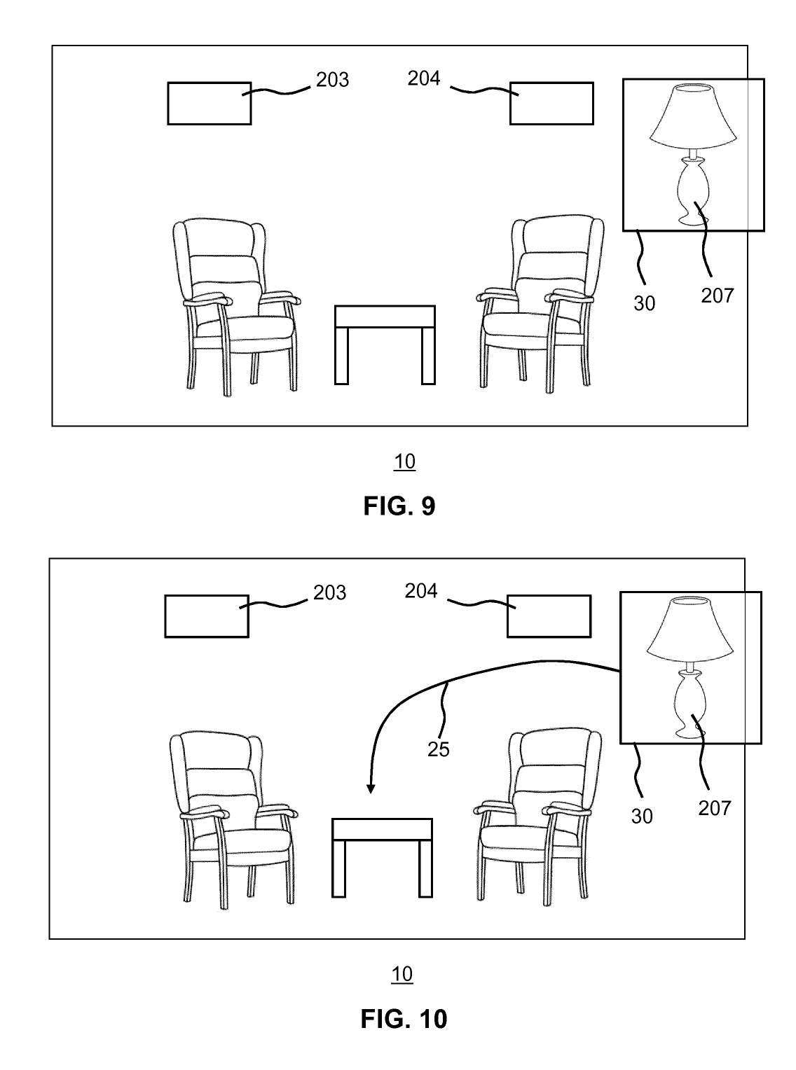

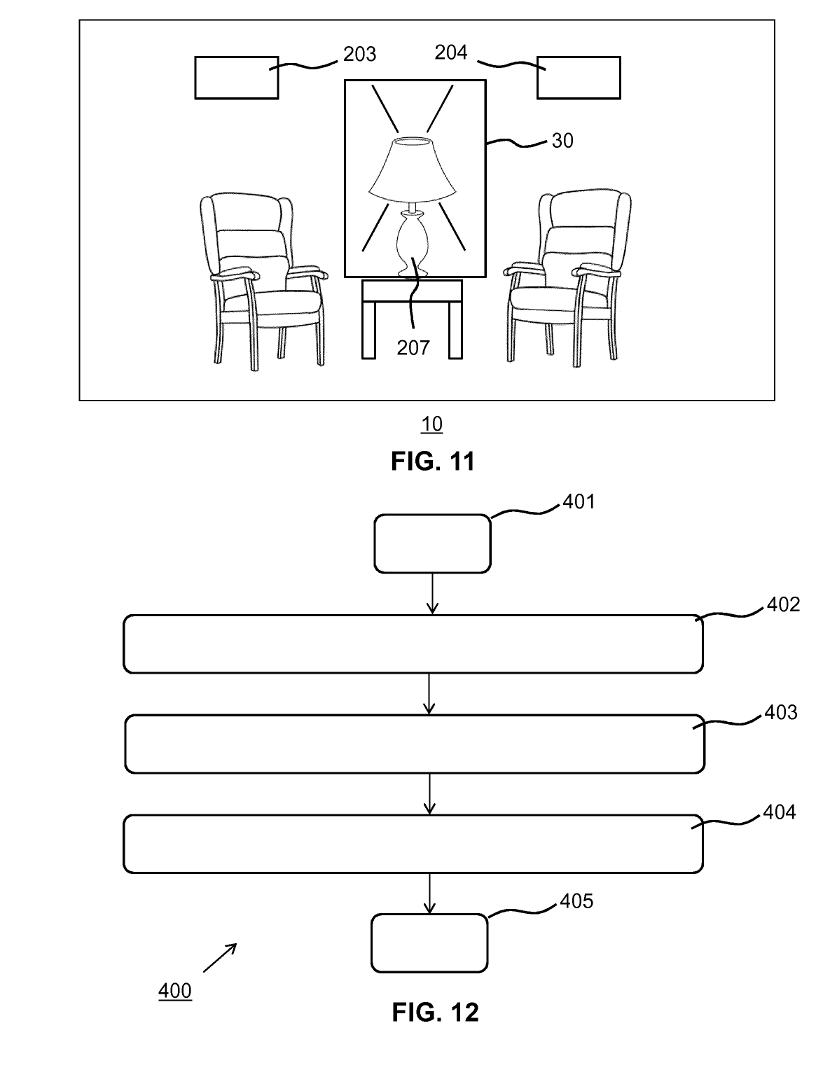

In accordance with another aspect, the wearable computing device 100 may be used to create an augmented reality of the lighting system 200, as will be explained with the aid of FIG. 9-11 and the flow chart of method 400 in FIG. 12. In accordance with this aspect, upon starting the method 400 in step 401, the wearer of the wearable computing device 100 may use the wearable computing device 100 to insert a virtual luminaire 207 into an actual view 10 of a lighting scene as seen through the see-through display 106 and provided in accordance with step 402 of method 400 in order to assess whether the insertion of the virtual luminaire 207 would have the desired (lighting) effect.

There are several reasons why the wearer of the wearable computing device 100 may want to create such an augmented reality. For instance, the wearer may want to redesign or extend the lighting system 200 by the introduction of additional luminaires into the lighting system 200. However, as it may be difficult to visualize the effect created by the additional luminaires, it may be undesirable to purchase the additional luminaires on a trial and error basis, for instance because of the cost associated with such a purchase.

To this end, the wearable computing device 100 may have access to a database of virtual luminaires of the lighting system 200, which database may be remotely accessible, e.g. via the Internet or a mobile communication protocol for instance, or which database may be locally accessible, e.g. in data storage 112. The wearer may provide the wearable computing device 100 with appropriate instructions to select the desired virtual luminaire from the database in accordance with step 403 of method 400, which causes the wearable computing device 100 to display an image 30 of a selected virtual luminaire 207 in an actual view 10 of a space that may include one or more luminaires of the lighting system 200, here luminaires 203 and 204.

As shown in FIG. 10, the wearer of the wearable computing device 100 may subsequently move the virtual luminaire 207 to a desired location within the actual view 10, i.e. to a desired location within the space viewed through the see-through display 106, e.g. by providing the wearable computing device 100 with an appropriate migration instruction 25, e.g. in the form of a head movement, gesture or the like as previously explained. The wearable computing device 100 detects the migration instruction 25 and migrates the image 30 of the virtual luminaire 207 in accordance with the migration instruction such that the image 30 is superimposed on the actual view 10 as shown in FIG. 11.

The virtual luminaire 207 may subsequently be configured to produce a desired virtual lighting atmosphere, for instance in accordance with an embodiment of the method of FIG. 3 or alternatively by selecting a predefined virtual lighting atmosphere, thereby creating an augmented actual view 10 as per step 404 of the method 400. The virtual lighting atmosphere created by the virtual luminaire 207 may be simulated by the processor 110 of the wearable computing device 100. As such light distributions relations are well-known per se, this will not be explained in further detail for the sake of brevity only. Upon creation of the augmented actual view 10, the method 400 may terminate in step 405.

In an embodiment, the luminaires 203 and 204 in the actual view 10 are configured to recreate a desired lighting atmosphere as previously explained. However, it should be understood that the method of creating the augmented actual view including one or more virtual luminaires may be equally applicable to an actual view of a lighting system or part thereof, in which the luminaires of the lighting system have been configured in any suitable manner.

Upon creation of the augmented actual view 10, the wearer of the wearable computing device 100 will be presented with a simulated lighting atmosphere including luminaires 203, 204 and virtual luminaire 207, such that the effect of the virtual luminaire 207 on the overall lighting atmosphere can be assessed. This therefore facilitates the wearer to make a more informed decision about the purchase of the luminaire 207.

Aspects of the present invention may be embodied as a lighting system kit, wearable computing device, method or computer program product. Aspects of the present invention may take the form of a computer program product embodied in one or more computer-readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Such a system, apparatus or device may be accessible over any suitable network connection; for instance, the system, apparatus or device may be accessible over a network for retrieval of the computer readable program code over the network. Such a network may for instance be the Internet, a mobile communications network or the like. More specific examples (a non-exhaustive list) of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present application, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out the methods of the present invention by execution on the processor 110 may be written in any combination of one or more programming languages, including an object oriented programming language such as Java, Smalltalk, C++ or the like and conventional procedural programming languages, such as the “C” programming language or similar programming languages. The program code may execute entirely on the processor 110 as a stand-alone software package, e.g. an app, or may be executed partly on the processor 110 and partly on a remote server. In the latter scenario, the remote server may be connected to the wearable computing device 100 through any type of network, including a local area network (LAN) or a wide area network (WAN), or the connection may be made to an external computer, e.g. through the Internet using an Internet Service Provider.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions to be executed in whole or in part on the processor 110 of the wearable computing device 100, such that the instructions create means for implementing the functions/acts specified in the flowchart and/or block diagram block or blocks. These computer program instructions may also be stored in a computer-readable medium that can direct the wearable computing device 100 to function in a particular manner.

The computer program instructions may be loaded onto the processor 110 to cause a series of operational steps to be performed on the processor 110, to produce a computer-implemented process such that the instructions which execute on the processor 110 provide processes for implementing the functions/acts specified in the flowchart and/or block diagram block or blocks.

The lighting system 200 may be provided as a lighting system kit together with a computer program product, e.g. an app, for implementing embodiments of the method 300. The computer program product may form part of a wearable computing device 100, e.g. may be installed on the wearable computing device 100.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method for controlling a lighting system including at least one luminaire with a wearable computing device comprising a see-through display and an image capturing element, the method comprising, with the wearable computing device:
capturing, with the image capturing element, an image of a space including a luminaire of said lighting system, said image corresponding to an actual view of said space through the see-through display;
identifying the luminaire in said image through image analysis of said image;
displaying an image of a desired lighting atmosphere on said see-through display;
associating the luminaire in said actual view with the desired lighting atmosphere by overlaying the luminaire in the actual view with the displayed desired lighting atmosphere; and
communicating with the lighting system to instruct the luminaire to recreate said lighting atmosphere.

2. The method of claim 1, wherein:
the actual view includes several luminaires of said lighting system;
said identifying step comprises identifying each of said several luminaires; and
wherein said associating step comprises associating at least one of said several luminaires in said actual view with the desired lighting atmosphere.

3. The method of claim 1, wherein said associating step comprises selecting a single luminaire in said actual view.

4. The method of claim 3, wherein the step of selecting said single luminaire comprises overlaying the single luminaire in said actual view with the displayed desired lighting atmosphere.

5. The method of claim 1, further comprising calculating a lighting characteristic for the luminaire from the displayed desired lighting atmosphere, wherein said instructing step includes communicating the calculated lighting characteristic from the wearable computing device to the lighting system.

6. The method of claim 5, wherein the lighting characteristic includes at least one of colour, colour temperature, intensity, saturation and lighting effect dynamics.

7. (canceled)

8. The method of claim 1, further comprising capturing the image of the desired lighting atmosphere with the image capturing element or retrieving the image of the desired lighting atmosphere from an external source.

9. The method of claim 8, wherein the image of the desired lighting atmosphere forms part of a sequence of images defining a dynamic desired lighting atmosphere, and wherein said instructing step comprises instructing the lighting system to recreate the dynamic desired lighting atmosphere.

10. The method of claim 1, further comprising communicating an adjustment to a lighting atmosphere recreated by the luminaire from the wearable computing device to the lighting system in response to an adjustment instruction received by the wearable computing device.

11. The method of claim 1, further comprising:
displaying a virtual luminaire on said see-through display; and
migrating the virtual luminaire to a location in the actual view to create an augmented view depicting an augmented lighting atmosphere in accordance with a migration command received by the wearable computing device.

12. The method of claim 1, further comprising controlling, at the lighting system, the luminaire in accordance with the received communication to recreate the desired lighting atmosphere.

13. A computer program product embodying computer program code, when executed on a processor of a wearable computing device that further comprises a see-through display and an image capturing element, implement or is capable of implementing the steps of the method of claim 1.

14. A wearable computing device comprising:
the computer program product of claim 13;
a processor adapted to execute the computer program code;
a see-through display;
an image capturing element; and
a communication arrangement for communicating with a lighting system including at least one luminaire.

15. A lighting system kit comprising:
a lighting system including at least one luminaire; and
the computer program product of claim 13.
